(19) United States
(12) Patent Application Publication
(10) Pub. No.: US 2024/0163951 A1
(43) Pub. Date: May 16, 2024

(54) METHOD FOR TRANSMITTING INFORMATION, METHOD FOR PROCESSING INFORMATION AND APPARATUSES THEREOF

(71) Applicant: FUJITSU LIMITED, Kawasaki-shi Kanagawa (JP)

(72) Inventors: Su YI, Beijing (CN); Meiyi JIA, Beijing (CN); Guorong LI, Beijing (CN); Shinichiro AIKAWA, Kawasaki-shi Kanagawa (JP)

(73) Assignee: FUJITSU LIMITED, Kawasaki-shi Kanagawa (JP)

(21) Appl. No.: 18/419,705

(22) Filed: Jan. 23, 2024

Related U.S. Application Data
(63) Continuation of application No. PCT/CN2021/110406, filed on Aug. 3, 2021.

(51) Int. Cl. H04W 76/19; H04W 76/15

(52) U.S. Cl. CPC H04W 76/19; H04W 76/15

(57) ABSTRACT

An apparatus for transmitting information, applicable to a first node, includes: processor circuitry configured to connect to a plurality of parent nodes, wherein a radio link failure (RLF) occurs in a master cell group (MCG); and a transmitter configured to transmit failure information to an F1-terminating node of the first node via first F1 application protocol (F1AP) signaling.

### CROSS-REFERENCE TO RELATED APPLICATION

This application is a continuation application of International Application PCT/CN2021/110406 filed on Aug. 3, 2021 and designated the U.S., the entire contents of which are incorporated herein by reference.

### TECHNICAL FIELD

This disclosure relates to the field of communication technologies.

### BACKGROUND

Integrated access and backhaul (IAB) realizes a function of wireless relay in a next generation radio access network (NG-RAN). This relay node is referred to as an IAB-node, which simultaneously supports access and backhaul (BH) via New Radio (NR). The IAB-node is connected to an IAB-donor via one or more hops. These multi-hop connections form a directed acyclic graph (DAG) topology with an IAB-donor as a root node. The IAB-donor is responsible for executing centralized resource management, topology management and routing management in an IAB network topology.

The IAB-node supports a function of a gNB-DU (distributed unit), an IAB-node DU is also referred to as an IAB-DU. The IAB-DU may serve for a common user equipment (UE) and IAB child node. In addition to the gNB-DU function, the IAB-node also supports some functions of the UE, referred to as an IAB-MT (mobile termination). The IAB-MT may support such functions as a UE physical layer, an access stratum (AS), a radio resource control (RRC) layer and a non-access stratum (NAS), and may be connected to an IAB parent node. A terminating node at a network side is referred to as an IAB-donor, which provides access to a network for the IAB-MT or the UE via a backhaul or access link.

The IAB-donor is further divided into an IAB-donor-CU (central unit) and an IAB-donor-DU. The IAB-DU and IAB-donor-CU are connected via an F1 interface. In a scenario of independent networking, a gNB and the IAB-donor-CU are connected via an Xn interface, and in deployment of non-independent networking, an eNB (evolved NodeB) and an en-gNB (which may be an IAB-donor) are connected via an X2 interface.

FIG. 1 is a schematic diagram of the IAB topology. As shown in FIG. 1, in 5G multi-hop network deployment, a plurality of UEs are connected to an IAB-donor via multi-hop IAB-nodes, and are finally accessed to a 5G network. In IAB topology 10, an IAB-node 100 includes an IAB-MT functional unit 101 and an IAB-DU functional unit 102, neighboring node preceding the IAB-MT are referred to as IAB parent nodes, such as IAB parent nodes 301 and 302 shown in FIG. 1, the IAB-MT functional unit 101 may be in communication with the IAB parent nodes 301 and 302 via an air interface (Uu). Neighboring nodes following the IAB-DU are referred to as IAB child nodes, such as IAB child nodes 201, 202 and 203 shown in FIG. 1, and the IAB-DU functional unit 102 may be in communication with the IAB child nodes 201, 202 and 203 via an air interface (Uu).

As shown in FIG. 1, a direction from the IAB-node 100 to the child nodes 201, 202 and 203 is referred to as a downstream direction, and a direction from the IAB-node 100 to the parent nodes 301 and 302 is referred to as an upstream direction. And the IAB-donor (not shown) executes centralized resource, topology and routing management for the IAB topology 10.

In order to support multi-hop routing transferring of data packets, IAB has introduced a backhaul adaptation protocol (BAP) sublayer. The BAP sublayer is located above a radio link control RLC sublayer and below a network protocol IP layer, and supports such functions as packet destination node and path selection, packet routing transferring, bearer mapping, flow control feedback, and BH link failure notification, etc.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY OF THE DISCLOSURE

In the existing standard (3GPP Rel-16), when a radio link failure (RLF) occurs in an IAB-node, including receiving a backhaul (BH) radio link failure indication, the IAB-node may select another path in a BAP sublayer to achieve BAP re-routing. FIG. 2 shows simple IAB network deployment, wherein a plurality of UEs are connected to the IAB-donor via multi-hop IAB-nodes, and are finally connected to the 5G network, in which four IAB-nodes and one IAB-donor are included. When IAB-node 3 detects that a radio link failure (RLF) occurs in a link between it and the IAB-donor and fails in performing RLF recovery, IAB-node 3 will transmit a BH RLF indication to a child node IAB-node 2. The BH RLF instruction is transmitted via a BAP control protocol data unit (PDU). If RRC reestablishment is not initiated, IAB-node 2 will hand an uplink BAP routing path from path 1 (path id #1) over to path 2 (path id #2).

However, it was found by the inventors that for uplink transferred data of IAB-nodes (such as data of F1-U and F1-C), an uplink backhaul link may be handed over by local re-routing, thereby avoiding a parent node transmitting a BH RLF notification. The local re-routing occurs at a BAP sublayer of the IAB-node. However, for control plane data of an IAB-MT itself, such as RRC (radio resource control) and NAS (non-access stratum) data, they pass through an access link, but do not pass through the BAP sublayer at this IAB-node, hence, local re-routing is not applicable to these data.

In addition, at the control plane, if a radio link failure occurs in the IAB-MT in a master cell group (MCG), the IAB-MT is configured with split signaling radio bearer (SRB) 1 or SRB 3, timer T316 is configured and is not in an operating state, the IAB-MT may continue to perform RRC connection in a fast MCG recovery process via a secondary cell group (SCG), without needing to perform an RRC reestablishment process.

However, it was found by the inventors that when a radio link failure occurs in the IAB-node, if the IAB-MT is not configured with split SRB 1 or SRB 3, it is unable to perform a fast MCG recovery process, and is only able to perform RRC reestablishment. The reestablishment process is time-consuming and may lead to data service interruption.

In addition, when the IAB-node receives a new type of BH RLF, behaviors of the control plane are not specified. If the IAB-MT still transmits an uplink RRC message in an original method, it is possible that transmission of an RRC uplink message fails due to a radio link failure of the parent node.

In order to solve at least one of the above problems, embodiments of this disclosure provide a method for transmitting information, a method for processing information and apparatuses thereof.

According to an aspect of the embodiments of this disclosure, there is provided an apparatus for transmitting information, applicable to a first node, wherein the apparatus includes:
a first processing unit configured to connect to a plurality of parent nodes, wherein a radio link failure occurs in a master cell group (MCG); and
a first transmitting unit configured to transmit failure information to an F1-terminating node of the first node via first F1 application protocol (F1AP) signaling.

According to another aspect of the embodiments of this disclosure, there is provided an apparatus for processing information, applicable to a first node, wherein the apparatus includes:
a first receiving unit configured to receive second-type backhaul radio link failure indication information transmitted by a parent node to which a first cell group corresponds; and
a second processing unit configured to set a primary path of a first signaling radio bearer to be referring to a second cell group different from the first cell group when the first signaling radio bearer of the first node is configured as a split signaling radio bearer and a primary path of a packet data convergence protocol (PDCP) entity of the first signaling radio bearer refers to the first cell group.

According to a further aspect of the embodiments of this disclosure, there is provided an apparatus for transmitting information, applicable to a first node, wherein the apparatus includes:
a third receiving unit configured to receive second-type backhaul radio link failure indication information transmitted by a parent node to which a first cell group corresponds; and
a second transmitting unit configured to transmit a first RRC message to a network device connected to a second cell group via a signaling radio bearer corresponding to the second cell group or transmit a first RRC message to an F1-terminating node via a first F1AP signaling.

An advantage of the embodiments of this disclosure exists in that when an MCG radio link failure occurs, failure information is transmitted via F1-C signaling, thereby achieving fast recovery of the MCG, avoiding connection interruption, reducing data loss, and achieving optimization of network performances.

Another advantage of the embodiments of this disclosure exists in that an RRC message carried by an SRB satisfying a condition may be migrated from a first cell group link to a second cell group link, thereby achieving non-interrupted transmission of a control plane, and ensuring normal communication of IAB-nodes during link recovery of the first cell group parent node.

A further advantage of the embodiments of this disclosure exists in that after a node receives a BH RLF indication indicating that a parent node to which a cell group corresponds detects a radio link failure, contents of an SRB are transmitted via another cell group, thereby supporting path re-selection of the control plane when a link failure occurs in the parent node, avoiding connection interruption, reducing data loss, and achieving optimization of network performances.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is a schematic diagram of an IAB topology of an embodiment of this disclosure;

FIG. 2 is a schematic diagram of IAB network deployment of the embodiment of this disclosure;

FIG. 3 is a schematic diagram of the method for transmitting information of an embodiment of this disclosure;

FIGS. 4A to 4D are schematic diagrams of a dual-connectivity network architecture of the embodiment of this disclosure;

FIG. 5 is a schematic diagram of a method for processing information of an embodiment of this disclosure;

FIG. 6 is a schematic diagram of the method for processing information of an embodiment of this disclosure;

FIG. 7 is a schematic diagram of the method for transmitting information of an embodiment of this disclosure;

FIG. 8 is a schematic diagram of the method for transmitting information of an embodiment of this disclosure;

FIG. 9 is a schematic diagram of an RRC transfer procedure of an embodiment of this disclosure;

FIG. 10 is a schematic diagram of the method for transmitting information of an embodiment of this disclosure;

FIG. 11 is a schematic diagram of an RRC transfer procedure of an embodiment of this disclosure;

FIGS. 12A to 12D are schematic diagrams of dual-connectivity network architectures of the embodiment of this disclosure;

FIG. 13 is a schematic diagram of the method for processing information of an embodiment of this disclosure;

FIG. 14 is a schematic diagram of the method for transmitting information of an embodiment of this disclosure;

FIG. 15 is a schematic diagram of the apparatus for transmitting information of an embodiment of this disclosure;

FIG. 16 is a schematic diagram of the apparatus for processing information of an embodiment of this disclosure;

FIG. 17 is another schematic diagram of the apparatus for transmitting information of the embodiment of this disclosure;

FIG. 18 is another schematic diagram of the apparatus for transmitting data of the embodiment of this disclosure;

FIG. 19 is another schematic diagram of the apparatus for processing information of an embodiment of this disclosure;

FIG. 20 is a further schematic diagram of the apparatus for processing information of an embodiment of this disclosure;

FIG. 21 is still another schematic diagram of the apparatus for processing information of an embodiment of this disclosure;

FIG. 22 is yet another schematic diagram of the apparatus for processing information of an embodiment of this disclosure;

FIG. 23 is a schematic diagram of a terminal equipment of an embodiment of this disclosure;

FIG. 24 is a schematic diagram of the IAB-node protocol stack of an embodiment of this disclosure;

FIG. 25 is another schematic diagram of the method for processing information of the embodiment of this disclosure; and

FIG. 26 is a schematic diagram of the network device of an embodiment of this disclosure.

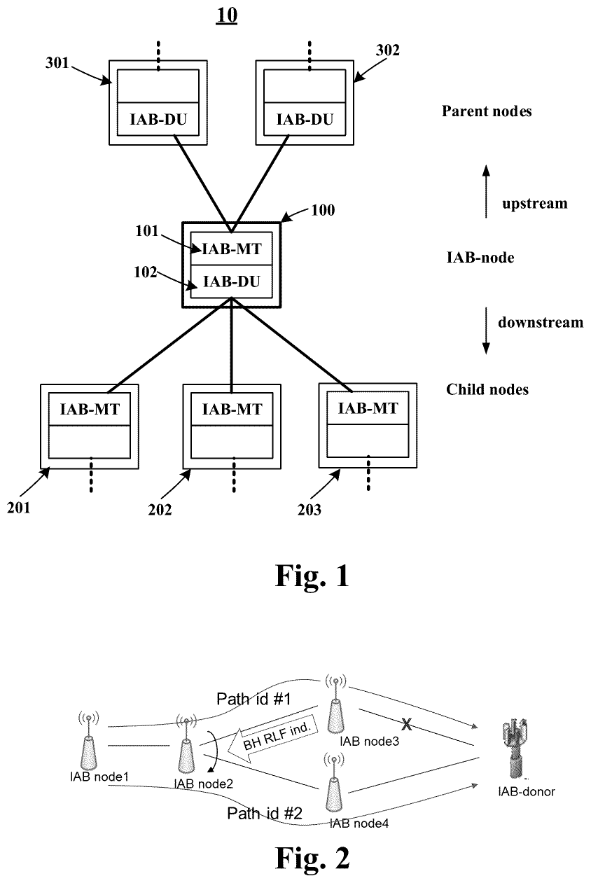

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G and 5G and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term. Without confusion, terms “cell” and “base station” are interchangeable, and terms “signaling” and “message” are interchangeable.

In the embodiments of this disclosure, the term “user equipment (UE)” or “terminal equipment (TE) or terminal device” refers to, for example, an equipment accessing to a communication network and receiving network services via a network device. The terminal equipment may be fixed or mobile, and may also be referred to as a mobile station (MS), a terminal, a subscriber station (SS), an access terminal (AT), an access terminal (AT), an IAB-MT, or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. In this text, “device” may refer to a network device, and may also refer to a terminal equipment, except otherwise specified.

FIG. 24 is a schematic diagram of an IAB-node control plane protocol stack of an embodiment of this disclosure. As shown in FIG. 24, an IAB-MT may support functions of a UE physical layer, a media access control (MAC) layer, radio link layer control (RLC), a packet data aggregation protocol (PDCP), a radio resource control (RRC) layer, and a non-access stratum (NAS) layer, and may be connected to an IAB parent node. The RRC and NAS are carried by signaling radio bearers (SRBs) established by the IAB-MT to an IAB-donor-CU. These SRBs are transmitted via a Uu interface between the IAB-MT and its parent node. Following control plane data of the IAB-node refer to signaling carried by the SRBs established by the IAB-MT to the IAB-donor, such as RRC, and the NAS, etc.

Embodiments of this disclosure provide a mechanism for implementing re-selection of IAB-node control plane links, so as to avoid loss of control plane data and maintain normal connection of a network.

The embodiments of this disclosure shall be further described below. In the embodiments of this disclosure, “when . . . ”, “in a case where . . . ”, “for a case where . . . ” and “if . . . ” represent being based on one or conditions or states, etc. In addition, such expressions are interchangeable. Furthermore, “indication” may be either explicitly containing certain information for notification, or implicitly notifying via certain features, etc.

How to achieve fast MCG recovery if no split SRB1 or SRB3 is configured when a MCG radio link failure occurs in an IAB-node shall be described below with reference to an embodiments of a first aspect.

### Embodiments of the First Aspect

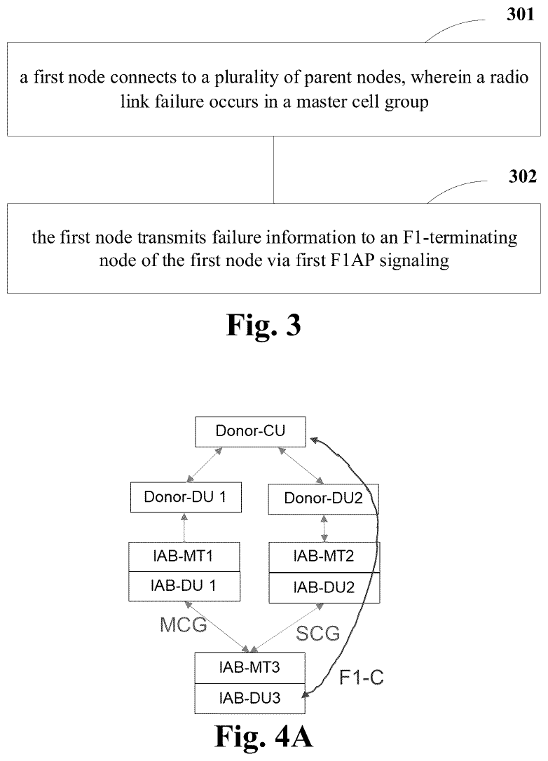

The embodiments of this disclosure provides a method for transmitting information. FIG. 3 is a schematic diagram of the method for transmitting information of the embodiments of this disclosure. As shown in FIG. 3, the method includes:
301: a first node connects to a plurality of parent nodes, wherein a radio link failure occurs in a master cell group (MCG); and
302: the first node transmits failure information to an F1-terminating node of the first node via first F1 application protocol (F1AP) signaling.

In some embodiments, the first node connects to a plurality of parent nodes, for example, the first node is a dual-connectivity node. When the first node is an IAB-node, it may be dual connected to the same donor-node or different donor-nodes. This is an example only, and the first node may also be other dual-connectivity nodes in a communication network, and the embodiments of this disclosure is not limited thereto.

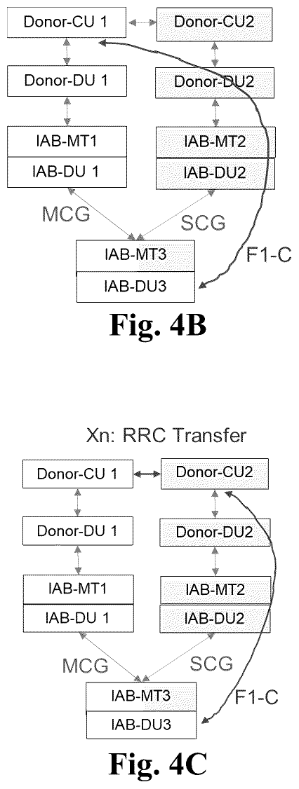

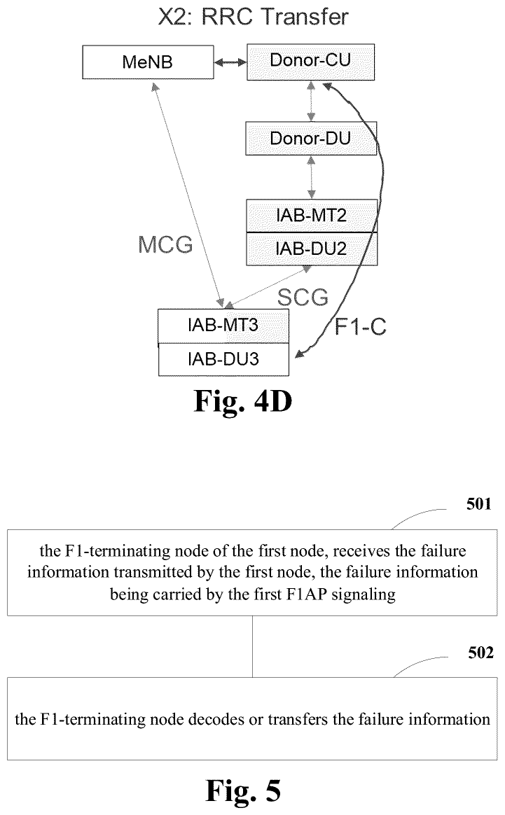

FIGS. 4A to 4D show schematic diagrams of four dual-connectivity network architectures. FIGS. 4A to 4D respectively show F1 control plane (F1-C) transmission paths from a DU of the first node (IAB-DU 3 in the figures) to a CU (donor-CU) of the IAB donor-node. As shown in FIGS. 4A and 4B, F1 of IAB-DU 3 is terminated to a master node (MN), and as shown in FIGS. 4C and 4D, F1 of IAB-DU 3 is terminated to a secondary node (SN). In FIGS. 4A to 4C, it is NR-NR dual-connectivity (NR-DC), and in FIG. 4D, it is E-UTRA-NR dual-connectivity (EN-DC). In FIG. 4A, the first node is dual connected to the same donor-node donor-CU, and in FIGS. 4B and 4C, the first node is dual connected to two different donor-node donor-CU1 and donor-CU2. What described above are examples only, and the dual-connectivity network has other scenarios, which shall not be described herein any further. In addition, the first node may also support two or more connections, which shall not be enumerated herein any further.

In some embodiments, a master cell group (MCG) and a secondary cell group (SCG) are included in a dual-connectivity scenario. That a radio link failure occurs in the master cell group MCG in the first node includes that the first node itself detects a radio link failure RLF or receives backhaul radio link failure indication information transmitted by a parent node at its MCG side. Wherein, when the parent node detects that a backhaul radio link failure in a link between it and the IAB-donor and fails in RLF recovery, the parent node will transmit the backhaul radio link failure indication information (such as a type-4 BH RLF indication, transmitted by a BAP control PDU). Reference may be made to existing technique for how to determine that a radio link failure occurs and a type of the radio link failure, which shall not be described herein any further.

In some embodiments, the signaling radio bearers (SRBs) include SRB0, SRB1, SRB2 and SRB3, wherein SRB0, SRB1 and SRB2 lead to the MN and SRB3 lead to the SN. The signaling radio bearers are radio bearers used to transmit the RRC and NAS message. SRB0 transmits an RRC message using a common control channel (CCCH) logical channel. SRB1 transmits an RRC message (which may include a piggybacked NAS messages) and an NAS message before SRB2 is established, and uses a dedicated control channel (DCCH) logical channel. SRB2 transmits an NAS message and an RRC message containing a log measurement message, and uses a DCCH logical channel. SRB2 is lower than SRB1 with respect to priority and may be configured by a network after an access layer (AS) is securely activated. SRB3 is used for a specific RRC message when the UE is in (NG)EN-DC or NR-DC, and uses a DCCH logical channel. All MR-DC (multi radio dual connectivity) options of SRB1 and SRB2 support split signaling radio bearers. In the MR-DC scenario, SRBs between the MN and UE having RLC (radio link control) bearers in both the MCG and SCG are referred to as split signaling radio bearers (split SRBs), and may also be referred to as signaling radio bearer split.

In some embodiments, when an MCG radio link failure occurs at the first node, a T316 timer may be started. In existing techniques, when an IAB-MT is configured with split signaling radio bear (SRB) 1 or signaling radio bear 3 (SRB3), an RRC message for fast MCG link recovery may be transmitted via split SRB1 or SRB3, such as MCG failure information. In 302, if the MT of the first node (such as an IAB-MT) is not configured with split SRB1 or SRB3, when the DU of the first node (such as an IAB-DU) and the IAB-donor-CU establish F1 interface control plane (F1-C) connection in a direction passing through the SCG link, in 302, the DU of the first node (such as the IAB-DU) may transmit the RRC message for fast MCG link recovery, such as MCG failure information, via the first F1AP signaling, and F1-C connection to which the first F1AP signaling belongs passes through the SCG link.

In some embodiments, the F1 interface is a connection interface between a gNB-DU (including an IAB-DU) and a gNB CU (including an IAB-donor-CU). An F1-C application layer signaling protocol is referred to as an F1 application protocol (F1AP). How to use first F1AP signaling to transmit an RRC message related to performing fast MCG link recovery shall be described below in detail, wherein the message related to performing fast MCG link recovery includes failure information, which is MCG failure information (MCGFailureInformation) and may be used to be reported to a master node, and the master node generates MCG failure recovery information.

In some embodiments, the first F1AP signaling may reuse existing F1AP signaling, or may use newly-established F1AP signaling.

For example, the first F1AP signaling may reuse a UL RRC MESSAGE TRANSFER message (hereinafter referred to as first signaling) during a UL RRC message transfer procedure in existing F1AP signaling. The message is transmitted from a gNB DU to a gNB CU, and may contain an RRC container information element (RRC-container IE). The failure message MCGFailureInformation is carried by the RRC-container, that is, the RRC-container IE is used to carry a packet data convergence protocol (PDCP) protocol data unit (PDU) encapsulating the RRC message (i.e. the UL-DCCH-Message). In addition, the first signaling is UE associated F1AP signaling, and contains UE-related identifiers, such as a gNB-CU UE F1AP ID, and a gNB-DU UE F1AP ID. As the MCG failure information is independent of a UE under the IAB-node, any identification information of UE that has already obtained an F1AP ID may be placed into an IE (information element) in a corresponding message, or dummy information may be placed therein, and the embodiments of this disclosure is not limited thereto. The Donor-CU will ignore the UE identifier when receiving the message.

For example, the first F1AP signaling may be newly-established F1AP signaling, such as newly-established second signaling. For example, the message may be referred to as UL RRC message transfer IAB, and may contain an RRC container information element (RRC-container IE), and the RRC-container is used to carry the failure information MCGFailureInformation, that is, the RRC container IE is used to carry the PDCP PDU encapsulating the failure information. The message will correspond to a new message type. The message type is used to uniquely identify a message, and includes a procedure code and a message type within the procedure, that is, each message name corresponds to different message types. In addition, the second signaling is non-UE associated F1AP signaling, that is, the second signaling does not need to include UE-related identifiers. The second signaling may further include at least one piece of information of a signaling radio bearer identifier (SRB ID) and a transaction identifier (transaction ID). The failure information carried by the RRC container in the first and second signaling is identical, with a difference being that the second signaling uses non-UE-related F1AP signaling, which does not include a UE ID, but may include a transaction ID.

For example, the first F1AP signaling may be newly-established F1AP signaling, such as newly-established third signaling. For example, a message of the third signaling is referred to as UL RRC message transfer MRDC, and may contain an RRC container information element (RRC-container IE), and the RRC-container is used to carry the failure information MCGFailureInformation, that is, the RRC container IE is used to carry a PDCP PDU encapsulating the failure information. In addition, the third signaling is identical to the information carried by the RRC-container in the first signaling. The third signaling is UE-associated F1AP signaling, and reference may be made to the first signaling for details. The third signaling is further used to indicate that an F1-terminating node needs to further transfer the information carried by the RRC-container, such as transferring to a master node. Furthermore, a message type of the third signaling is different from that of the first signaling. That is, message contents of the third signaling and first signaling are identical except for the message types. The message type is used to distinguish whether the F1-terminating node needs to further transfer the information carried by the RRC-container, or used to distinguish whether the RRC container information element is transmitted to the F1-terminating node or needs to be transferred.

For example, the first F1AP signaling may be newly-established F1AP signaling, such as newly-established fourth signaling. For example, a message of the fourth signaling is referred to as UL RRC message transfer LAB MRDC, and may contain an RRC container information element (RRC-container IE), and the RRC-container is used to carry the failure information MCGFailureInformation, that is, the RRC container IE is used to carry a PDCP PDU encapsulating the failure information. In addition, the fourth signaling is identical to the information carried by the RRC-container in the second signaling. The fourth signaling is non-UE-associated F1AP signaling, and reference may be made to the second signaling for details. The fourth signaling is further used to indicate that an F1-terminating node needs to further transfer the information carried by the RRC-container, such as transferring to a master node. Furthermore, a message type of the fourth signaling is different from that of the second signaling. That is, message contents of the fourth signaling and second signaling are identical except for the message types. The message type is used to distinguish whether the F1-terminating node needs to further transfer the information carried by the RRC-container, or used to distinguish whether the RRC container information element is transmitted to the F1-terminating node or needs to be transferred.

In some embodiments, the F1-terminating node may decode or transfer the failure information carried by the first F1AP signaling after receiving it, and reference may be made to following FIG. 5 for an implementation thereof, which shall not be repeated herein any further. The F1-terminating node may determine whether itself is a message destination node according to the received first F1AP signaling, and further determine whether a corresponding action is transferring or decoding. Wherein, when it is not a message destination node (such as a secondary node), transferring is performed, and when it is a destination node (such as a master node), decoding is performed.

In some embodiments, first indication information may be added to the first signaling or second signaling, the first indication information being used to indicate whether the F1-terminating node is a message destination node; or, the F1-terminating node may also determine whether itself is a message destination node according to whether the first F1AP signaling is third signaling or fourth signaling, which shall be described below.

For example, the first signaling or second signaling may include the first indication information. For example, the first indication information may be denoted by using an information element, such as an information element referred to as Transfer MRDC. A value of the information element is true or false, and when the F1-terminating node is a secondary node, the value of the information element is set to be true, when the F1-terminating node is a master node, the value of the information element is set to be false, and vice versa; or, the information element may also be denoted by a bit value. When the F1-terminating node is a secondary node, the value of the information element is set to be 1, when the F1-terminating node is a master node, the value of the information element is set to be 0, and vice versa, and the embodiments of this disclosure is not limited thereto. For example, when the F1-terminating node includes the first indication information in the first signaling or second signaling and the first indication information is false, it determines that itself is a destination node, and decoding may be performed directly. And when the first indication information is true, it determines that itself is not a destination node and needs to transfer the failure information to the master node. What described above is exemplary only, and this disclosure is not limited thereto, which shall not be enumerated herein any further.

For example, the F1-terminating node may also determine whether itself is a message destination node according to whether the first F1AP signaling is the third signaling. When the F1-terminating node is a master node, the first signaling UL RRC MESSAGE TRANSFER message is used to carry the failure information, and when the F1-terminating node is a secondary node, the third signaling is used to carry the failure information, that is, when the F1-terminating node receives the first signaling, it determines that itself is a destination node, and decoding may be performed directly, and when it receives the third signaling, it determines that itself is not a destination node and needs to transfer the failure information to the master node. What described above is exemplary only, and this disclosure is not limited thereto, which shall not be enumerated herein any further.

For example, the F1-terminating node may also determine whether itself is a message destination node according to whether the first F1AP signaling is the fourth signaling. When the F1-terminating node is a master node, the second signaling UL RRC MESSAGE TRANSFER message is used to carry the failure information, and when the F1-terminating node is a secondary node, the fourth signaling is used to carry the failure information, that is, when the F1-terminating node receives the second signaling, it determines that itself is a destination node, and decoding may be performed directly, and when it receives the fourth signaling, it determines that itself is not a destination node and needs to transfer the failure information to the master node. What described above is exemplary only, and this disclosure is not limited thereto, which shall not be enumerated herein any further.

In some embodiments, after the master node generates failure recovery information according to the failure information, the F1-terminating node may further carry the failure recovery information by the second F1AP signaling to transmit or transfer to the first node. Therefore, this method may further include (not shown):
the first node receives, the failure recovery information transmitted or transferred by the F1-terminating node, the failure recovery information being carried by the second F1AP signaling.

In some embodiments, the failure recovery information is MCG failure recovery information, which includes at least one of a handover command, an RRC reconfiguration message, and an RRC connection release message, and reference may be made to existing techniques for details.

In some embodiments, when the IAB-DU and IAB-donor-CU of the first node establish F1 interface control plane (F1-C) connection in a direction passing an SCG link, the DU of the first node (such as the IAB-DU) may receive MCG failure recovery information via the second F1AP signaling, the F1-C connection to which the second F1AP signaling belongs being identical to the F1-C connection to which the first F1AP signaling belongs, both of which pass through the SCG link.

In some embodiments, the second F1AP signaling may reuse existing F1AP signaling, or may use newly-established F1AP signaling.

For example, the second F1AP signaling may reuse a DL RRC MESSAGE TRANSFER message (fifth signaling) in a DL RRC message transfer procedure in existing F1AP signaling, which may contain an RRC container information element (RRC container IE), and the RRC-container is used to carry the failure recovery information, that is, the RRC-container IE is used to carry the PDCP PDU encapsulating the RRC message (i.e. DL-DCCH-Message). In addition, the second F1AP signaling is UE-associated F1AP signaling, and contains a UE-related identifier, which is similar to the UE-related identifier in the first F1AP signaling, and shall not be repeated herein any further.

For example, the second F1AP signaling may be newly-established F1AP signaling, such as newly-established DL RRC message transfer IAB signaling (sixth signaling), which may contain an RRC container information element (RRC container IE), and the RRC-container is used to carry the failure recovery information, that is, the RRC-container IE is used to carry the PDCP PDU encapsulating the failure recovery information. In addition, the second F1AP signaling is non-UE-associated F1AP signaling, that is, the second F1AP signaling does not need to contain a UE-related identifier.

The method for transmitting information is described above from a side of the first node, and shall be described below from a side of the F1-terminating node. FIG. 5 is a schematic diagram of a method for processing information as the side of the F1-terminating node. As shown in FIG. 5, the method includes:
501: the F1-terminating node of the first node receives, the failure information transmitted by the first node, the failure information being carried by the first F1AP signaling; and
502: the F1-terminating node decodes or transfers the failure information.

In some embodiments, 501 corresponds to 302, and reference may be made to 302 for implementations of the failure information and the first F1AP signaling, which shall not be repeated herein any further.

In some embodiments, in 502, when the F1-terminating node is a secondary node, the secondary node transfers the failure information to the master node. As contents in the RRC-Container are transmitted transparently, there is no need to decode the contents in the RRC-Container when the F1-terminating node is a secondary node. After receiving the failure message, the secondary node carries the failure information in the RRC-Container in an X2 or Xn interface message to transfer to the master node. For example, an RRC Transfer message is used, and reference may be made to 3GPP TS36.423 and TS38.423 for a definition of the message, which shall not be repeated herein any further. When the F1-terminating node is a master node or when the master node receives the failure information transferred by the secondary node, the failure information may be decoded directly.

In some embodiments, the implementation of the first F1AP signaling is as described above, and the F1-terminating node may determine whether itself is a message destination node according to the received first F1AP signaling, and further determine whether a corresponding action is transferring or decoding. Wherein, when it is not a message destination node (such as a secondary node), it performs transferring, and when it is a destination node (such as a master node), is performs decoding.

In some embodiments, the first indication information may be added to the first signaling or second signaling to indicate whether the F1-terminating node is a message destination node; or, the F1-terminating node may also determine whether itself is a message destination node according to whether the first F1AP signaling is the third signaling or fourth signaling, which is as described above and shall not be repeated herein any further.

In some embodiments, after the master node receives the RRC-Container carried in F1-C or transferred by the secondary node and decodes the failure information, it generates (MCG) failure recovery information, and the method may further include (not shown):
the F1-terminating node transmits or transfers the failure recovery information to the first node, the failure recovery information being carried by the second F1AP signaling.

In some embodiments, when the F1-terminating node is a master node, it transmits the failure recovery information to the DU of the first node (such as the IAB-DU) via F1-C connection identical to that transmitting the failure information; and when the F1-terminating node is a secondary node, the master node first transmits the failure recovery information to the secondary node via an X2 or Xn interface, and the secondary node transfers the failure recovery information to the DU of the first node (such as the IAB-DU) via the F1-C connection identical to that transmitting the failure information. The second F1AP signaling is as described above and shall not be repeated herein any further.

In some embodiments, the method may further include (not shown):
the F1-terminating node receives, second indication information transmitted by a third network device, the second indication information being used to indicate to transfer the received RRC message to the first node via the second F1AP signaling.

In some embodiments, when the F1-terminating node is a secondary node, the secondary node may further receive the second indication information transmitted by a third network device (a master node) and the failure recovery information transmitted by the master node (the second indication information and failure recovery information being carried by identical or different X2AP/XnAP signaling), the second indication information being used to indicate that the secondary node transfers the received RRC message (the failure recovery information) to the first node via the second F1AP signaling. After receiving the second indication information and failure recovery information, the secondary node transmits the failure recovery information to the first node (the IAB-DU) via F1-C connection identical to that transmitting the failure information. The second indication information may be included in a secondary node modification preparation X2AP or XnAP procedure initiated by the master node to configure the secondary node, or may be placed in an RRC Transfer X2AP or XnAP procedure and transmitted to the secondary node along with the RRC message.

It should be noted that FIGS. 3-5 only schematically illustrate the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIGS. 3-5.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiments that when an MCG radio link failure occurs, the failure information is transmitted via the F1-C signaling, thereby achieving fast MCG recovery, avoiding connection interruption, reducing data loss, and achieving network performance optimization.

How to achieve information uploading and perform cell group reselection when the first node receives second-type backhaul RLF indication information shall be described below with reference to the second and third aspects.

### Embodiments of the Second Aspect

The embodiments of this disclosure provides a method for processing information, applicable to a scenario where SRB1 or SRB2 is configured as a split SRB, which shall be described from a side of the first node, with contents identical to those in the embodiments of the first aspect being not going to be described herein any further.

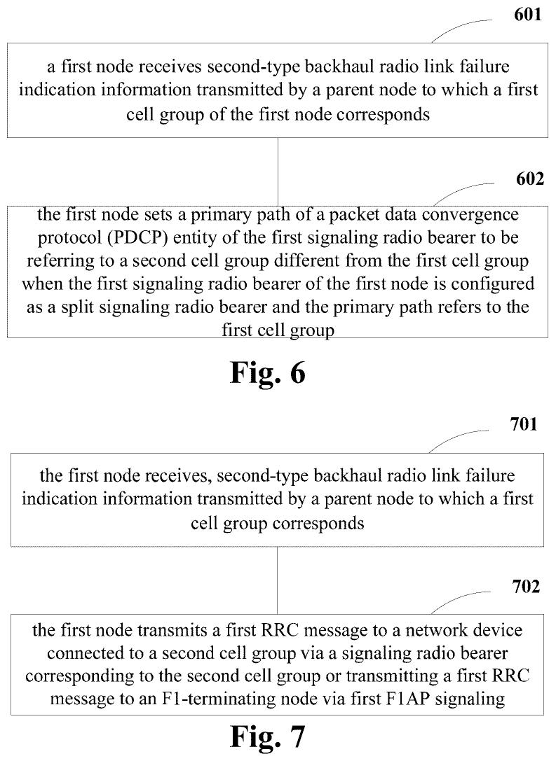

FIG. 6 is a schematic diagram of the method for processing information of this embodiment. As shown in FIG. 6, the method includes:
601: a first node receives, second-type backhaul radio link failure indication information transmitted by a parent node to which a first cell group of the first node corresponds; and
602: the first node sets a primary path of a packet data convergence protocol (PDCP) entity of the first signaling radio bearer to be referring to a second cell group different from the first cell group when the first signaling radio bearer of the first node is configured as a split signaling radio bearer and the primary path refers to the first cell group.

In some embodiments, the second-type backhaul radio link failure indication information is transmitted by the parent node when detecting a radio link failure, which is, for example, type 2 BH radio link failure indication information, and is transmitted via a BAP control PDU. The first signaling radio bearer is SRB1 or SRB2, but the first SRB is not configured with PDCP duplication transmission (pdcp-Duplication). Reference may be made to the first embodiments for a meaning of the first node, which shall not be repeated herein any further.

In some embodiments, when the first cell group is a master cell group and the second cell group is a secondary cell group, the first node (such as an IAB-MT) receives the second-type BH RLF indication information from the MCG, and when the SRB1 of the first node (such as the IAB-MT) is configured as a split signaling radio bearer, when the primary path of the PDCP entity of SRB1 refers to the MCG, the primary path is set to be referring to the SCG.

In some embodiments, when the first cell group is a master cell group and the second cell group is a secondary cell group, the first node (such as the IAB-MT) receives the second-type BH RLF indication information from the MCG, and when the SRB2 of the first node (such as the IAB-MT) is configured as a split signaling radio bearer, when the primary path of the PDCP entity of SRB2 refers to the MCG, the primary path is set to be referring to the SCG.

It can be seen from the above embodiments that the RRC and NAS messages carried by the SRBs satisfying the above conditions may be migrated from the MCG link to the SCG link, thereby achieving non-interrupted transmission of the control plane and ensuring normal communication of IAB-nodes during a link recovery period of the MCG parent node.

In some embodiments, the first IAB-node transmits an uplink RRC message or NAS message via the second cell group, the RRC message or NAS message originally needing to be transmitted via the first cell group.

In some embodiments, when the first cell group is a secondary cell group and the second cell group is a master cell group, the first node (such as the IAB-MT) receives the second-type BH RLF indication information from the SCG, and when the SRB1 of the first node (such as the IAB-MT) is configured as a split signaling radio bearer, when the primary path of the PDCP entity of the SRB1 refers to the SCG, the primary path is set to be referring to the MCG.

In some embodiments, when the first cell group is a secondary cell group and the second cell group is a master cell group, the first node (such as the IAB-MT) receives the second-type BH RLF indication information from the SCG, and when the SRB2 of the first node (such as the IAB-MT) is configured as a split signaling radio bearer, when the primary path of the PDCP entity of the SRB2 refers to the SCG, the primary path is set to be referring to the MCG.

It can be seen from the above embodiments that the RRC message carried by the SRB satisfying the above conditions may be migrated from the SCG link to the MCG link, thereby achieving non-interrupted transmission of the control plane and ensuring normal communication of IAB-nodes during a link recovery period of the SCG parent node.

In some embodiments, the method further includes (not shown): the first node receives, third-type backhaul radio link failure indication information transmitted by the parent node, and sets the primary path to be referring to the first cell group.

In some embodiments, the third-type backhaul radio link failure indication information (type 3 backhaul radio link failure indication information, which is transmitted by a BAP control PDU) is transmitted by the parent node to the first node (such as the IAB-MT) when the backhaul RLF recovery is successful. When the first node (such as the IAB-MT) receives the third-type backhaul radio link failure indication information transmitted by the parent node, it may migrate back a control plane transmission path that was originally migrated to another parent node link, that is, a transmission path before the second-type backhaul radio link failure indication information is received from the parent node is recovered to be used. For example, the primary path of the split SRB is recovered to its original setting (referring to an original cell group).

In some embodiments, when the first cell group is a master cell group and the second cell group is a secondary cell group, the first node (such as the IAB-MT) receives the third-type BH RLF indication information, and the primary path of the PDCP entity of SRB1 or SRB2 is recovered to referring to the MCG.

It should be noted that FIG. 6 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 6.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of the Third Aspect

The embodiments of this disclosure provides a method for transmitting information, applicable to a scenario where SRB1 or SRB2 is not configured as a split SRB, which shall be described from a side of the first node, with contents identical to those in the embodiments of the first or second aspect being not going to be described herein any further. Furthermore, the embodiments of the third aspect may be implemented in combination with the embodiments of the first and second aspects, or may be implemented separately.

FIG. 7 is a schematic diagram of the method for transmitting information of this embodiment. As shown in FIG. 7, the method includes:
701: the first node receives, second-type backhaul radio link failure indication information transmitted by a parent node to which a first cell group corresponds; and
702: the first node transmits a first RRC message to a network device connected to a second cell group via a signaling radio bearer corresponding to the second cell group or transmitting a first RRC message to an F1-terminating node via first F1AP signaling by the first node.

In some embodiments, the second-type backhaul radio link failure indication information is transmitted by the parent node when it detects a radio link failure, such as type 2 backhaul radio link failure indication information, and reference may be made to the embodiments of the first aspect for a meaning of the first node, which shall not be repeated herein any further.

In some embodiments, reference may be made to 601 for implementation of 701, which shall not be repeated herein any further.

When the first cell group is a master cell group and the second cell group is a secondary cell group, for a scenario where SRB1 is not configured as a split SRB, the first RRC message carried by SRB1 may be migrated in a manner as follows.

In some embodiments, the first node migrates the first RRC message via the signaling radio bearer (SRB1) corresponding to the master cell group to the signaling radio bearer (SRB3) corresponding to the secondary cell group for transmission. That is, when the first node (such as the IAB-MT) is configured with the SRB (i.e. SRB3) corresponding to the secondary cell group, the first node (such as the IAB-MT) transmits the first RRC message (the RRC message originally carried by SRB1) to the SN on the SRB (i.e. SRB3) corresponding to the secondary cell group. The first RRC message includes reply information of the RRC message received from the master cell group. The first RRC message includes, for example, at least one of measurement information MeasurementReport, failure information FailureInformation, assistance information UEAssistanceInformation, and reestablishment complete information RRCReconfigurationComplete. The first RRC message is carried in the second RRC message ULInformationTransferMRDC. In addition, after receiving the first RRC message transmitted via SRB3 (contents in the RRC message are transmitted transparently), the secondary node SN needs to transfer the first RRC message to the master node, such as carrying the first RRC message in the RRC Transfer procedure.

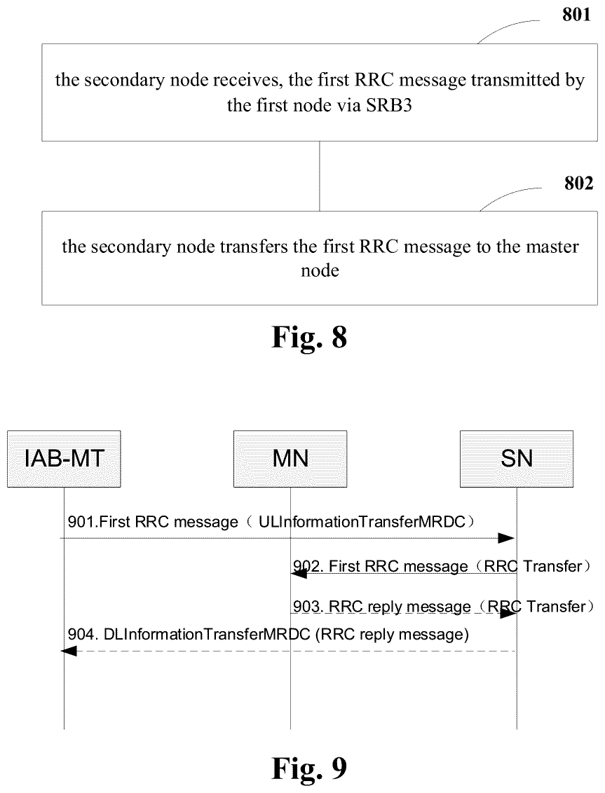

FIG. 8 is a schematic diagram of the method for transmitting information at a side of the secondary node. As shown in FIG. 8, the method for transmitting information includes:
801: the secondary node receives, the first RRC message transmitted by the first node via SRB3; and
802: the secondary node transfers the first RRC message to the master node.

FIG. 9 is a schematic diagram of the RRC transfer procedure. As shown in FIG. 9, in 901, the secondary node receives the first RRC message (such as being carried by ULInformationTransferMRDC) transmitted by the first node (such as the IAB-MT) via SRB3, and in 902, the secondary node carries the first RRC message in the RRC transfer procedure and transmits it to the master node. Optionally, if the master node needs to make response to the received first RRC message, this procedure may further include: 903: the MN initiates the RRC transfer procedure and taking an RRC reply message as an octet string and transmits it to the secondary node, and 904: the secondary node places the received RRC reply message in a third RRC message, such as transparent container DLInformationTransferMRDC, and transmits it to the IAB-MT. The RRC transfer procedure is implemented in an Xn or X2 interface protocol.

In some embodiments, if the F1-C link of the DU of the first node passes through the secondary cell group link of the MT, the first RRC message may be transmitted to the F1-terminating node via the first F1AP signaling. The first RRC message includes the reply information of the RRC message received from the master cell group. The first RRC message includes, for example, at least one of measurement information MeasurementReport, failure information FailureInformation, assistance information UEAssistanceInformation, and reestablishment complete information RRCReconfigurationComplete. The first F1AP signaling may be first to fourth signaling, and reference may be made to the embodiments of the first aspect for details, with the exception from the embodiments of the first aspect that the RRC message contained in the RRC container information element is different, and the rest is identical, which shall not be repeated herein any further.

When the first cell group is a master cell group and the second cell group is a secondary cell group, for a scenario where SRB2 is not configured as a split SRB, the first RRC message carried by SRB2 may be migrated in a manner as follows.

In some embodiments, the first node migrates the first RRC message via the signaling radio bearer (SRB2) corresponding to the master cell group to the signaling radio bearer (SRB3) corresponding to the secondary cell group for transmission. That is, when the first node (such as the IAB-MT) is configured with the SRB (i.e. SRB3) corresponding to the secondary cell group, the first node (such as the IAB-MT) transmits the first RRC message (such as being originally carried by SRB2) to the SN on the SRB (i.e. SRB3) corresponding to the secondary cell group. The first RRC message includes NAS information or non-3GPP specific information. The first RRC message includes such information as UEInformationResponse (when log measurement information is included) information and ULInformationTransfer information, and reference may be made to existing techniques for details. The first RRC message is carried in the second RRC message ULInformationTransferMRDC. In addition, after receiving the first RRC message (contents in the RRC message are transmitted transparently) transmitted via SRB3, the secondary node SN needs to transfer the first RRC message to the master node, such as carrying the first RRC message in the RRC Transfer procedure. Reference may be made to FIG. 9 for a specific procedure, with the exception from the embodiment concerning SRB1 being that the contents in the first RRC message are different.

In some embodiments, the first node transmits the first RRC message to the F1-terminating node via the first F1AP signaling on the secondary cell group link. The first RRC message includes NAS information or non-3GPP specific information, such as UEInformationResponse (when log measurement information is included) information, and ULInformationTransfer information, and reference may be made to existing techniques for details. The first F1AP signaling may be first to fourth signaling, and reference may be made to the embodiments of the first aspect for details, with the exception from the embodiments of the first aspect that the RRC message contained in the RRC container information element is different, and the rest is identical, which shall not be repeated herein any further.

When the first cell group is a secondary cell group and the second cell group is a master cell group, the first RRC message carried by SRB3 may be migrated in a manner as follows.

In some embodiments, the first node migrates the first RRC message via the signaling radio bearer (SRB3) corresponding to the secondary cell group to the signaling radio bearer (SRB1) corresponding to the master cell group for transmission. That is, the first node (such as the IAB-MT) transmits the first RRC message (such as being originally carried by SRB3) to the MN on the SRB (i.e. SRB1) corresponding to the master cell group. The first RRC message includes at least one of measurement information MeasurementReport, failure information FailureInformation, assistance information UEAssistanceInformation and other IAB information of the secondary cell group. The first RRC message is carried in the second RRC message ULInformationTransferMRDC. In addition, after receiving the first RRC message (contents in the RRC message are transmitted transparently) transmitted via SRB1, the master node MN may transfer the first RRC message to the secondary node, such as carrying the first RRC message in the RRC Transfer procedure.

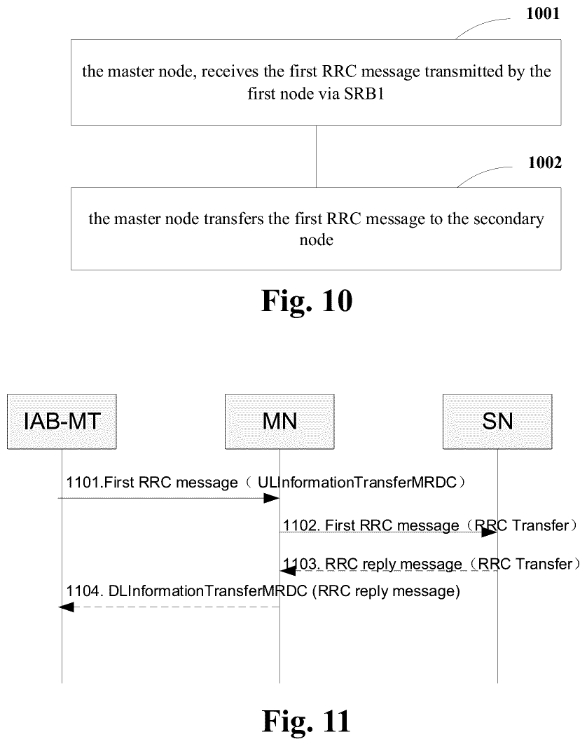

FIG. 10 is a schematic diagram of the method for transmitting information at a side of the master node. As shown in FIG. 10, the method for transmitting information includes:
1001: the master node receives, the first RRC message transmitted by the first node via SRB1; and
1002: the master node transfers the first RRC message to the secondary node.

FIG. 11 is a schematic diagram of the RRC transfer procedure. As shown in FIG. 11, in 1101, the master node receives the first RRC message (such as being carried by ULInformationTransferMRDC) transmitted by the first node (such as the IAB-MT) iva SRB1, and in 1102, the master node carries the first RRC message in the RRC transfer procedure and transmits it to the secondary node. Optionally, if the secondary node needs to make response to the received first RRC message, this procedure may further include: 1103: the SN initiates the RRC transfer procedure and taking an RRC reply message as an octet string and transmits it to the master node, and 1104: the master node places the received RRC reply message in a third RRC message, such as transparent container DLInformationTransferMRDC, and transmits it to the IAB-MT. The RRC transfer procedure is implemented in an Xn or X2 interface protocol.

In some embodiments, the F1-C link of the DU of the first node passes through the master cell group link of the MT, and the first RRC message may be transmitted to the F1-terminating node via the first F1AP signaling. The first RRC message includes at least one of measurement information MeasurementReport, failure information FailureInformation, assistance information UEAssistanceInformation, and other IAB information IABOtherInformation of the secondary cell group. The first F1AP signaling may be first to fourth signaling, and reference may be made to the embodiments of the first aspect for details, which shall not be repeated herein any further. An exception from the embodiments of the first aspect is that when the DU (such as the IAB-DU) of the first node and the IAB-donor-CU establishes F1 interface control plane (F1-C) connection in a direction passing the MCG link, an F1-C channel to which the first F1AP signaling belongs passes the MCG link. That is, the first RRC message of the SN, i.e. the RRC message originally transmitted via SRB3, is carried by the first F1AP signaling. Behaviors of the master node and secondary node in the embodiments of the first aspect are interchangeable.

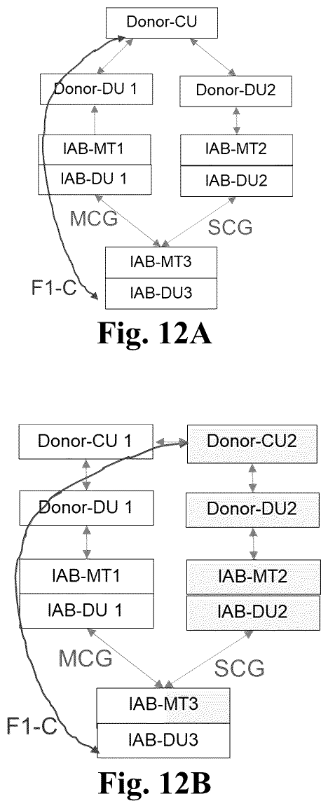

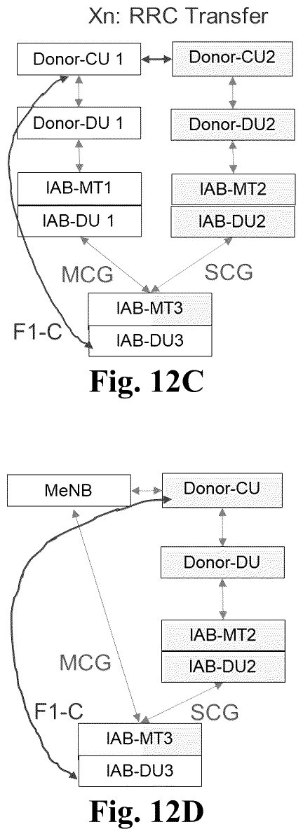

FIGS. 12A to 12D show schematic diagrams of four dual-connectivity network architecture. FIGS. 12A to 12D respectively show F1 control plane (F1-C) transmission paths from the DU of the first node (IAB-DU 3 in the figures) to the CU (donor-CU) of the IAB donor-node. As shown in FIGS. 12B and 12D, F1 of IAB-DU3 is terminated to the secondary node (SN); as shown in FIG. 12C, F1 of IAB-DU3 is terminated to the master node (MN). In FIG. 12A, the F1-terminating node donor-CU is both a master node and a secondary node, in FIGS. 12A to 12C, it is NR-NR dual-connectivity (NR-DC), and in FIG. 12D, it is E-UTRA-NR dual-connectivity (EN-DC). In FIG. 12A, the first node is dual connected to the same donor-CU. In FIGS. 12B and 12C, the first node is dual connected to two different donor-nodes, donor-CU1 and donor-CU2. As shown in FIG. 12C, the first RRC message of the IAB-MT is first transmitted to the master node via the RRC container in the F1-C signaling (the first F1AP signaling). After receiving the first RRC message, the master node transmits the first RRC message encapsulated in the PDCP PDU to the secondary node via the RRC transfer procedure, hence, the first RRC message undergoes two times of transparent transmission. As shown in FIGS. 12A, 12B and 12D, the first RRC message of the IAB-MT may be transmitted to the secondary node via the RRC container in F1-C signaling (the first F1AP signaling), and the first RRC message undergoes one time of transparent transmission. What described above is exemplary only, and there exist other scenarios of the dual-connectivity network, which shall not be described herein any further. In addition, the first node may also support more than two connections, which shall not be enumerated herein any further.

In some embodiments, when there exist cases where an SRB transmits the first RRC message and F1-C signaling carries the first RRC message, the network device side may configure using which mode for transmitting the first RRC message, and the method may further include (not shown):
the first node receives path reselection method configuration information transmitted by the network device, the path reselection method configuration information being used to indicate whether the first node transmits the first RRC message via the signaling radio bearer corresponding to the second cell group or transmits the first RRC message via the first F1AP signaling.

For example, the UE, i.e. the IAB-MT, is configured by using an existing RRCReconfiguration message, so as to carry the path reselection method configuration information, that is, adding an IE in the RRCReconfiguration message, such as being referred to as path reselection method configuration information pathReselectionMethod. A type of the IE may be enumerative, and an value there of may be ulInformationTransferMRDC (the first node transmits the first RRC message via the signaling radio bearer corresponding to the second cell group), and f1-c (the first RRC message is transmitted via the first F1AP signaling), etc.

In some embodiments, the method further includes (not shown): the first node receives third-type backhaul radio link failure indication information transmitted by the parent node, and transmits the first RRC message via the signaling radio bearer of the first cell group.

In some embodiments, the third-type backhaul radio link failure indication information (type 3 backhaul radio link failure indication information) is transmitted by the parent node to the first node (such as the IAB-MT) when the backhaul RLF recovery is successful. When receiving the third-type backhaul radio link failure indication information transmitted by the parent node, the first node (such as the IAB-MT) may migrate back the control plane transmission path that was originally migrated to another parent node link, that is, the transmission path before the second-type backhaul radio link failure indication information is received from the parent node is recovered to be used. For example, the first RRC message is transmitted by using the original signaling radio bearer of the first cell group, and ULInformationTransferMRDC or the first F1AP signaling is not used to carry the first RRC message.

In some embodiments, when the first cell group is a master cell group and the second cell group is a secondary cell group, the first node (such as the IAB-MT) receives the third-type BH RLF indication information, and resumes transmitting the first RRC message via SRB1 or SRB2.

In some embodiments, when the first cell group is a secondary cell group and the second cell group is a master cell group, the first node (such as the IAB-MT) receives the third-type BH RLF indication information, and resumes transmitting the first RRC message via SRB3.

It should be noted that FIGS. 7-12 only schematically illustrate the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIGS. 7-12.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiments that after a node receives a BH RLF indication indicating that a parent node to which a cell group corresponds detects a radio link failure, contents of an SRB are transmitted via another cell group, thereby supporting path re-selection of the control plane when a link failure occurs in the parent node, avoiding connection interruption, reducing data loss, and achieving optimization of network performances.

### Embodiments of a Fourth Aspect

The embodiments of this disclosure provides a method for processing information, which shall be described from a side of the first node, with contents identical to those in the embodiments of the first, second and third aspects being not going to be described herein any further. Furthermore, the embodiments of the fourth aspect may be implemented in combination with the embodiments of the first, second and third aspects, or may be implemented separately.

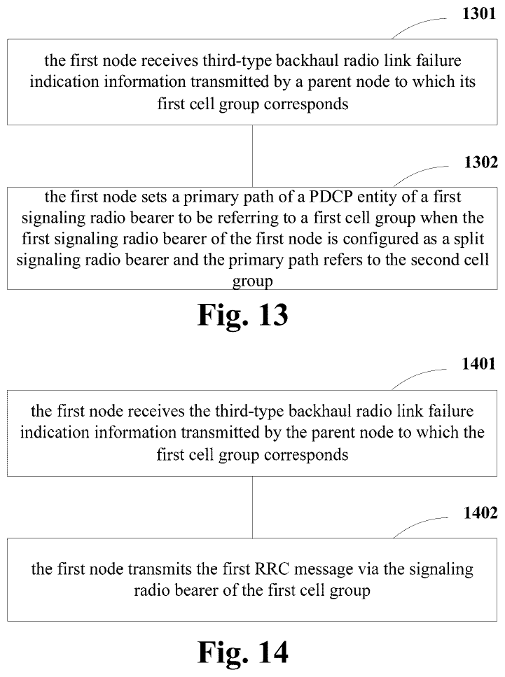

FIG. 13 is a schematic diagram of the method for processing information of this embodiment. As shown in FIG. 13, the method includes:
1301: the first node receives, third-type backhaul radio link failure indication information transmitted by a parent node to which its first cell group corresponds; and
1302: the first node sets a primary path of a PDCP entity of a first signaling radio bearer to be referring to a first cell group when the first signaling radio bearer of the first node is configured as a split signaling radio bearer and the primary path refers to the second cell group.

In some embodiments, the third-type backhaul radio link failure indication information (type 3 backhaul radio link failure indication information) is transmitted by the parent node to the first node (such as the IAB-MT) when backhaul RLF recovery is successful. When the first node (such as the IAB-MT) receives the third-type backhaul radio link failure indication information transmitted by the parent node, it may migrate back a control plane transmission path that was originally migrated to another parent node link, that is, a transmission path before the second-type backhaul radio link failure indication information is received from the parent node is recovered to be used. For example, the primary path of the split SRB is recovered to its original setting (referring to an original cell group).

In some embodiments, when the first cell group is a master cell group and the second cell group is a secondary cell group, the first node (such as the IAB-MT) receives the third-type BH RLF indication information, and the primary path of the PDCP entity of SRB1 or SRB2 is recovered to referring to the MCG.

FIG. 14 is a schematic diagram of the method for transmitting information of this embodiment. As shown in FIG. 14, the method includes:
1401: the first node receives, the third-type backhaul radio link failure indication information transmitted by the parent node to which the first cell group corresponds; and
1402: the first node transmits the first RRC message via the signaling radio bearer of the first cell group.

In some embodiments, the third-type backhaul radio link failure indication information (type 3 backhaul radio link failure indication information) is transmitted by the parent node to the first node (such as the IAB-MT) when the backhaul RLF recovery is successful. When receiving the third-type backhaul radio link failure indication information transmitted by the parent node, the first node (such as the IAB-MT) may migrate back the control plane transmission path that was originally migrated to another parent node link, that is, the transmission path before the second-type backhaul radio link failure indication information is received from the parent node is recovered to be used. For example, the first RRC message is transmitted by using the original signaling radio bearer of the first cell group, and ULInformationTransferMRDC or the first F1AP signaling is not used to carry the first RRC message.

In some embodiments, when the first cell group is a master cell group and the second cell group is a secondary cell group, the first node (such as the IAB-MT) receives the third-type BH RLF indication information, and resumes transmitting the first RRC message via SRB1 or SRB2.

In some embodiments, when the first cell group is a secondary cell group and the second cell group is a master cell group, the first node (such as the IAB-MT) receives the third-type BH RLF indication information, and resumes transmitting the first RRC message via SRB3.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Fifth Aspect

The embodiments of this disclosure provides a method for processing information, which shall be described from a side of the first node, with contents identical to those in the embodiments of the first, second and third aspects being not going to be described herein any further. Furthermore, the embodiments of the fifth aspect may be implemented in combination with the embodiments of the first, second and third aspects, or may be implemented separately.

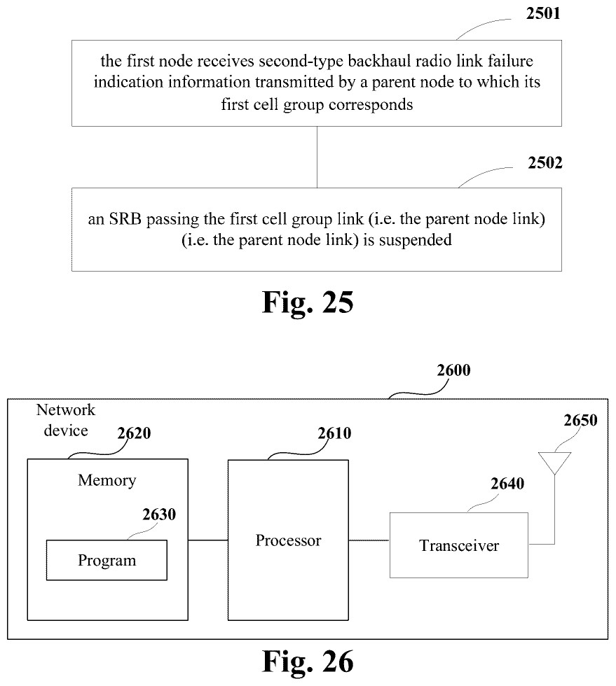

FIG. 25 is a schematic diagram of the method for processing information of this embodiment. As shown in FIG. 25, the method includes:
2501: the first node receives, second-type backhaul radio link failure indication information transmitted by a parent node to which its first cell group corresponds; and
2502: an SRB passing the first cell group link is suspended.

In some embodiments, the second-type backhaul radio link failure indication information is transmitted by the parent node when detecting a backhaul radio link failure, such as type 2 backhaul radio link failure indication information, and reference may be made to the embodiments of the first aspect for a meaning of the first node, which shall not be repeated herein any further.

In some embodiments, reference may be made to 601 for implementation of 2501, which shall not be repeated herein any further.

In some embodiments, in 2502, when SRB1 or SRB2 passing the first cell link (a parent node link) is not configured as a split SRB, the SRB is suspended.

In some embodiments, the method further includes (not shown): the first node receives, the third-type backhaul radio link failure indication information transmitted by the parent node, and resumes the suspended SRB passing the first cell group link.

In some embodiments, the third-type backhaul radio link failure indication information (type 3 backhaul radio link failure indication information) is transmitted by the parent node to the first node (such as the IAB-MT) when backhaul RLF recovery is successful. When receiving the third-type backhaul radio link failure indication information transmitted by the parent node, the first node (such as the IAB-MT) resumes the suspended SRB.

In some embodiments, when the first cell group is a master cell group, the first node (such as the IAB-MT) receives the second-type BH RLF indication information, suspends SRB1 and/or SRB2, and resumes the suspended SRB1 and/or SRB2 when receiving the third-type BH RLF indication information.

In some embodiments, when the first cell group is a secondary cell group, the first node (such as the IAB-MT) receives the second-type BH RLF indication information, suspends SRB3, and resumes the suspended SRB3 when receiving the third-type BH RLF indication information.

It should be noted that FIG. 25 only schematically illustrate the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 25.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Sixth Aspect

The embodiments of this disclosure provides an apparatus for transmitting information or an apparatus for processing information. The apparatus is applicable to a first node, such as an IAB-node (which is an example only; however, it is not limited thereto, and may also be one or more components or assemblies configured in the IAB-node, or another type of node), with contents identical to those in the embodiments of the first aspect being not going to be described herein any further.

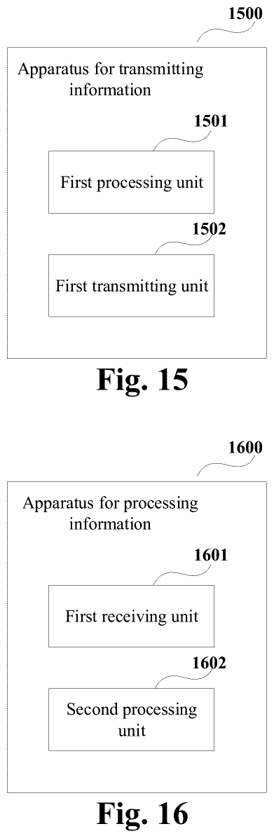

FIG. 15 is a schematic diagram of the apparatus for transmitting information of the embodiment of this disclosure. As shown in FIG. 15, the apparatus 1500 for transmitting information includes:
a first processing unit 1501 configured to connect to a plurality of parent nodes, wherein a radio link failure occurs in a master cell group (MCG); and
a first transmitting unit 1502 configured to transmit failure information to an F1-terminating node of the first node via first F1AP signaling.

In some embodiments, reference may be made to 301-302 for implementations of the first processing unit 1501 and the first transmitting unit 1502, which shall not be repeated herein any further.

In some embodiments, the first F1AP signaling is UE-associated F1AP signaling.

In some embodiments, the first F1AP signaling is non-UE associated F1AP signaling.

In some embodiments, the first F1AP signaling is used for uplink RRC message transfer.

In some embodiments, the first F1AP signaling further includes at least one of a signaling radio bearer identifier and a transaction identifier.

In some embodiments, the first node is not configured with a split signaling radio bearer 1 (SRB1) and a split signaling radio bearer 3.

In some embodiments, the first node is dual connected to the same donor node or different donor nodes, an F1-C channel to which the first F1AP signaling belongs passes a secondary cell group (SCG) link, and the failure information is MCG failure information.

In some embodiments, the first F1AP signaling further includes first indication information, the first indication information being used to indicate whether the F1-terminating node is a message destination node.

In some embodiments, first F1AP signaling to which different types of F1-terminating nodes correspond is different.

In some embodiments, the apparatus may further include (not shown, optional):
a fourth receiving unit configured to receive failure recovery information transmitted or transferred by the F1-terminating node, the failure recovery information being carried by second F1AP signaling.

In some embodiments, the failure recovery information is at least one of a handover command, an RRC reconfiguration message, and an RRC connection release message.

FIG. 16 is a schematic diagram of the apparatus for processing information of the embodiment of this disclosure. As shown in FIG. 16, the apparatus 1600 for processing information includes:
a first receiving unit 1601 configured to receive second-type backhaul radio link failure indication information transmitted by a parent node to which a first cell group corresponds; and
a second processing unit 1602 configured to set a primary path of a first signaling radio bearer to be referring to a second cell group different from the first cell group when the first signaling radio bearer of the first node is configured as a split signaling radio bearer and a primary path of a packet data convergence protocol (PDCP) entity of the first signaling radio bearer refers to the first cell group.

In some embodiments, reference may be made to 601-602 for implementations of the first receiving unit 1601 and the second processing unit 1602, which shall not be repeated herein any further.

In some embodiments, the first signaling radio bearer of the first node is not configured with PDCP-duplication.

In some embodiments, the second-type backhaul radio link failure indication information is transmitted by the parent node when a failure of a backhaul radio link is detected by the parent node.

In some embodiments, the apparatus may further include (not shown, optional):
a second receiving unit configured to receive third-type backhaul radio link failure indication information transmitted by the parent node; and
a third processing unit configured to set the primary path to be referring to the first cell group.

In some embodiments, the third-type backhaul radio link failure indication information is transmitted by the parent node when backhaul RLF recovery is successful.

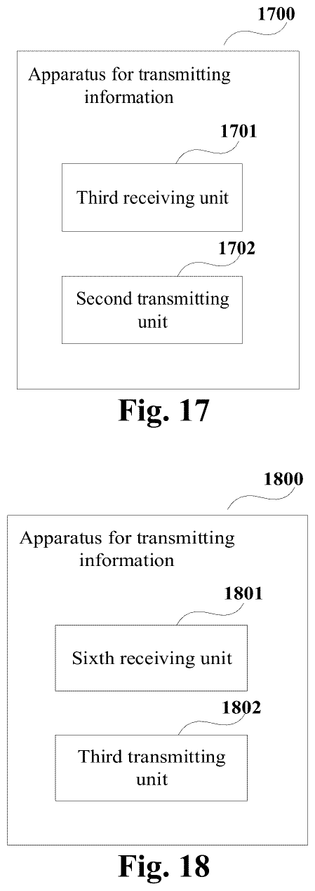

FIG. 17 is a schematic diagram of the apparatus for transmitting information of the embodiment of this disclosure. As shown in FIG. 17, the apparatus 1700 for transmitting information includes:
a third receiving unit 1701 configured to receive second-type backhaul radio link failure indication information transmitted by a parent node to which a first cell group corresponds; and
a second transmitting unit 1702 configured to transmit a first RRC message to a network device connected to a second cell group via a signaling radio bearer corresponding to the second cell group or transmit a first RRC message to an F1-terminating node via first F1AP signaling.

In some embodiments, reference may be made to 701-702 for implementations of the third receiving unit 1701 and the second transmitting unit 1702, which shall not be repeated herein any further.

In some embodiments, the first node is dual connected to the same donor node or different donor nodes.

In some embodiments, the first node transmits the first RRC message by migrating the first RRC message via a signaling radio bearer corresponding to the first cell group to a signaling radio bearer corresponding to the second cell group.

In some embodiments, the signaling radio bearer corresponding to the first cell group is not configured as a split signaling radio bearer.

In some embodiments, the first RRC message includes at least one of measurement information, failure information, assistance information and reconfiguration completion information; or, the RRC message includes NAS information or non-3GPP dedicated information.

In some embodiments, the first RRC message is carried in a second RRC message.

In some embodiments, the first F1AP signaling is UE-associated F1AP signaling.

In some embodiments, the first F1AP signaling is non-UE-associated F1AP signaling.

In some embodiments, the first F1AP signaling is used for uplink RRC message transfer.

In some embodiments, the first F1AP signaling further includes at least one piece of information in a signaling radio bearer identifier and a transaction identifier.

In some embodiments, the first F1AP signaling further includes first indication information, the first indication information being used to indicate whether the F1-terminating node is a message destination node.

In some embodiments, first F1AP signaling to which different types of F1-terminating nodes correspond is different.

In some embodiments, the second-type backhaul radio link failure indication information is transmitted by the parent node when a failure of a backhaul radio link is detected by the parent node.

In some embodiments, the apparatus may further include (not shown, optional):
a fifth receiving unit configured to receive path reselection method configuration information transmitted by a network device, the path reselection method configuration information being used to indicate whether the first node transmits the first RRC message via the signaling radio bearer corresponding to the second cell group or transmits the first RRC message via the first F1AP signaling.

FIG. 18 is a schematic diagram of the apparatus for transmitting information of the embodiment of this disclosure. As shown in FIG. 18, the apparatus 1800 for transmitting information includes:
a sixth receiving unit 1801 configured to receive third-type backhaul radio link failure indication information transmitted by the parent node to which the first cell group corresponds; and
a third transmitting unit 1802 configured to transmit the first RRC message via the signaling radio bearer of the first cell group.

In some embodiments, reference may be made to 1401-1402 for implementations of the sixth receiving unit 1801 and the third transmitting unit 1802, which shall not be repeated herein any further.

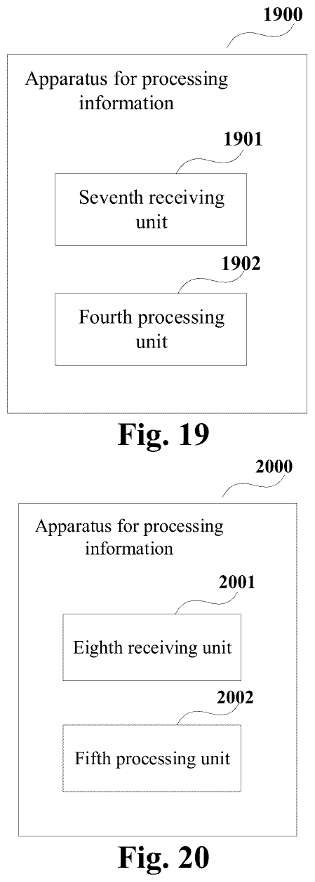

FIG. 19 is a schematic diagram of the apparatus for processing information of the embodiment of this disclosure. As shown in FIG. 19, the apparatus 1900 for processing information includes:
a seventh receiving unit 1901 configured to receive third-type backhaul radio link failure indication information transmitted by a parent node to which its first cell group corresponds; and
a fourth processing unit 1902 configured to set a primary path of a PDCP entity of a first signaling radio bearer to be referring to a first cell group when the first signaling radio bearer of the first node is configured as a split signaling radio bearer and the primary path refers to the second cell group.

In some embodiments, reference may be made to 1301-1302 for implementations of the seventh receiving unit 1901 and the fourth processing unit 1902, which shall not be repeated herein any further.

In some embodiments, the third-type backhaul radio link failure indication information is transmitted by the parent node when backhaul RLF recovery is successful.

FIG. 20 is a schematic diagram of the apparatus for processing information of the embodiment of this disclosure. As shown in FIG. 20, the apparatus 2000 for processing information includes:
an eighth receiving unit 2001 configured to receive second-type backhaul radio link failure indication information transmitted by a parent node to which its first cell group corresponds; and
a fifth processing unit 2002 configured to suspend an SRB passing the first cell group link.

In some embodiments, reference may be made to 2501-2502 for implementations of the eighth receiving unit 2001 and the fifth processing unit 2002, which shall not be repeated herein any further.

In some embodiments, the fifth processing unit 2002 suspends the SRB when SRB1 or SRB2 passing the first cell link (the parent node link) is not configured as a split SRB.

In some embodiments, the apparatus further includes (not shown, optional):
a seventh receiving unit configured to receive third-type backhaul radio link failure indication information transmitted by the parent node; and
a sixth processing unit configured to resume the suspended SRB passing the first cell group link.

### Embodiments of a Seventh Aspect

The embodiments of this disclosure provides an apparatus for processing information, which is applicable to a network node, with contents identical to those in the embodiments of the first to fourth aspects being not going to be repeated herein any further.

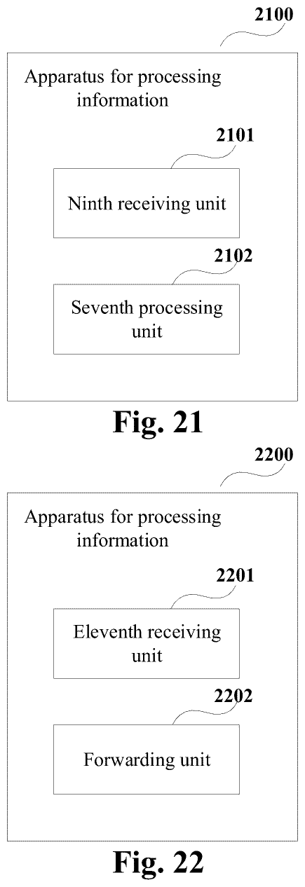

FIG. 21 is a schematic diagram of the apparatus for processing information of the embodiment of this disclosure, the apparatus being applicable to an F1-terminating node of a first node. As shown in FIG. 21, the apparatus 2100 for processing information includes:
a ninth receiving unit 2101 configured to receive the failure information transmitted by the first node, the failure information being carried by the first F1AP signaling; and
a seventh processing unit 2102 configured to decode or transfer the failure information.

In some embodiments, the apparatus further includes (not shown, optional):
a fourth transmitting unit configured to transmit or transfer failure recovery information to the first node, the failure recovery information being carried by the second F1AP signaling.
a tenth receiving unit configured to receive second indication information and failure recovery information transmitted by a third network device, the second indication information being used to indicate that the F1-terminating node transfers the received RRC message to the first node via the second F1AP signaling.

In some embodiments, when the F1-terminating node is a secondary node, it transfers the failure information to the master node.

In some embodiments, the first F1AP signaling further includes first indication information, the first indication information being used to indicate whether the F1-terminating node is a message destination node.

In some embodiments, the F1-terminating node determines to decode or transfer the failure information according to the first indication information.

In some embodiments, first F1AP signaling to which different types of F1-terminating nodes correspond is different.

FIG. 22 is a schematic diagram of the apparatus for processing information of the embodiment of this disclosure, the apparatus being applicable to a second network device. As shown in FIG. 22, the apparatus 2200 for processing information includes:
an eleventh receiving unit 2201 configured to receive an RRC message transmitted via a signaling radio bearer to which the second cell group corresponds or a first RRC message transmitted via the first F1AP signaling by the first node; and
a transferring unit 2202 configured to transfer the first RRC message to the first network device.

In some embodiments, when the second network device is a master network device of the first node and the first network device is a secondary network device of the first node, the apparatus further includes:
a twelfth receiving unit configured to receive an RRC reply message transmitted by the first network device when the first network device initiates an RRC transfer procedure.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the apparatuses in FIGS. 15-22 may further include other components or modules, and reference may be made to related techniques for particulars of these components or modules.

Furthermore, for the sake of simplicity, connection relationships between the components or modules or signal profiles thereof are only illustrated in FIGS. 15-22. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### Embodiments of an Eighth Aspect

The embodiments of this disclosure provides a communication system, with contents identical to those in the embodiments of the first to seventh aspects being not going to be described herein any further.

In some embodiments, the communication system may include a first node, including the apparatus 1500 for transmitting information described in the embodiments of the sixth aspect, which executes the method for transmitting information described in the embodiments of the first aspect.

In some embodiments, the communication system may include a first node, including the apparatus 1600 for transmitting information described in the embodiments of the sixth aspect, which executes the method for processing information described in the embodiments of the second aspect.

In some embodiments, the communication system may include a first node, including the apparatus 1700 for transmitting information described in the embodiments of the sixth aspect, which executes the method for transmitting information described in the embodiments of the third aspect.

In some embodiments, the communication system may include a first node, including the apparatus 1800 for transmitting information or the apparatus 1900 for processing information described in the embodiments of the sixth aspect, which executes the method for transmitting information or the method for processing information described in the embodiments of the fourth aspect.

In some embodiments, the communication system may include a first node, including the apparatus 2000 for processing information described in the embodiments of the sixth aspect, which executes the method for processing information described in the embodiments of the fifth aspect.

In some embodiments, the communication system may include a network node, including the apparatus for processing information described in the embodiments of the first or third aspect, which executes the method for processing information described in the embodiments of the first or third aspect. The above implementations may be executed separately, or may be executed in a combined manner, and the embodiments of this disclosure is not limited thereto.

Wherein, the first node may include an IAB-DU functional unit, and may further include an IAB-MT functional unit. Wherein, the IAB-MT functional unit may have a structure same as that of a terminal equipment, and the IAB-DU/donor CU functional unit may have a structure same as that of a network device.

FIG. 26 is a schematic diagram of the network device of the embodiment of this disclosure. As shown in FIG. 26, the network device 2600 may include a processor 2610 (such as a central processing unit (CPU)) and a memory 2620, the memory 2620 being coupled to the processor 2610. Wherein, the memory 2620 may store various data, and furthermore, it may store a program 2630 for information processing, and execute the program 2630 under control of the processor 2610.

For example, the processor 2610 may be configured to execute a program to carry out the method executed by the parent node of the first node or the network device or the network node or the F1-terminating node as described in the embodiments of the first or third aspect.

Furthermore, as shown in FIG. 26, the network device 2600 may include a transceiver 2640, and an antenna 2650, etc.; wherein functions of the above components are similar to those in the related art, which shall not be described herein any further. It should be noted that the network device 2600 does not necessarily include all the parts shown in FIG. 26. Furthermore, the network device 2600 may include parts not shown in FIG. 26, and the related art may be referred to.

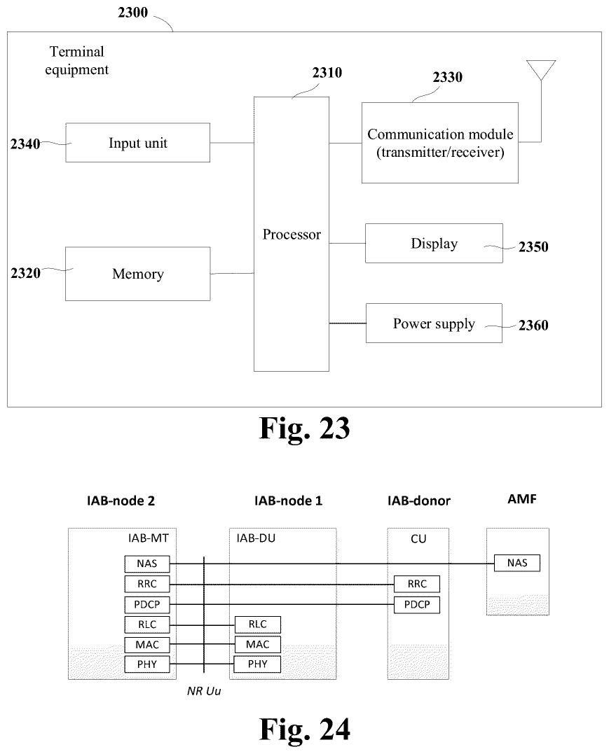

FIG. 23 is a schematic diagram of a terminal equipment of an embodiment of this disclosure. As shown in FIG. 23, the terminal equipment 2300 may include a processor 2310 and a memory 2320, the memory 2320 storing data and programs and being coupled to the processor 2310. It should be noted that this figure is illustrative only, and other types of structures may also be used, so as to supplement or replace this structure and achieve a telecommunications function or other functions. For example, the terminal equipment 2300 may be configured to execute a program to carry out the method executed by the first node as described in the embodiments of the first or second or third or fourth or fifth aspect.

As shown in FIG. 23, the terminal equipment 2300 may further include a communication module 2330, an input unit 2340, a display 2350, and a power supply 2360; wherein functions of the above components are similar to those in the related art, which shall not be described herein any further. It should be noted that the terminal equipment 2300 does not necessarily include all the parts shown in FIG. 23, and the above components are not necessary. Furthermore, the terminal equipment 2300 may include parts not shown in FIG. 23, and the related art may be referred to.

An embodiment of this disclosure provides a computer readable program code, which, when executed in a first node, will cause the first node to carry out the method for transmitting information or the method for processing information as described in the embodiments of any one of the first to the fifth aspects.

An embodiment of this disclosure provides a computer readable medium, including a computer readable program code, which will cause a first node to carry out the method for transmitting information or the method for processing information as described in the embodiments of any one of the first to the fifth aspects.

An embodiment of this disclosure provides a computer readable program code, which, when executed in a network node, will cause the network node to carry out the method for processing information as described in the embodiments of the first or the third aspect.

An embodiment of this disclosure provides a computer readable medium, including a computer readable program code, which will cause a network node to carry out the method for processing information as described in the embodiments of the first or the third aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations including the above embodiments, following supplements are further disclosed.

1. A method for transmitting information, characterized in that the method comprises:
connecting to a plurality of parent nodes by a first node, wherein a radio link failure occurs in a master cell group (MCG); and
transmitting failure information by the first node to an F1-terminating node of the first node via first F1AP signaling.

2. The method according to supplement 1, wherein the first F1AP signaling is UE-associated F1AP signaling.

3. The method according to supplement 1, wherein the first F1AP signaling is non-UE-associated F1AP signaling.

4. The method according to supplement 1, wherein the first F1AP signaling is used for uplink RRC message transfer.

5. The method according to supplement 3, wherein the first F1AP signaling further comprises at least one of a signaling radio bearer identifier and a transaction identifier.

6. The method according to supplement 1, wherein the first node is not configured with a split signaling radio bearer 1 (SRB1) and a split signaling radio bearer 3.

7. The method according to supplement 1, wherein the first node is dual connected to the same donor node or different donor nodes, an F1-C channel to which the first F1AP signaling belongs passes a secondary cell group (SCG) link, and the failure information is MCG failure information.

8. The method according to supplement 1, wherein the first F1AP signaling further comprises first indication information, the first indication information being used to indicate whether the F1-terminating node is a message destination node.

9. The method according to supplement 1, wherein first F1AP signaling to which different types of F1-terminating nodes correspond is different.

10. The method according to supplement 1, wherein the method further comprises:
receiving, by the first node, failure recovery information transmitted or transferred by the F1-terminating node, the failure recovery information being carried by second F1AP signaling.

11. The method according to supplement 10, wherein the failure recovery information is at least one of a handover command, an RRC reconfiguration message, and an RRC connection release message.

12. An method for processing information, characterized in that the method comprises:
receiving, by an F1-terminating node of a first node, failure information transmitted by the first node, the failure information being carried by first F1AP signaling; and
decoding or transferring the failure information by the F1-terminating node.

13. The method according to supplement 12, wherein the method further comprises:
transmitting or transferring the failure recovery information by the F1-terminating node to the first node, the failure recovery information being carried by the second F1AP signaling.

14. The method according to supplement 13, wherein the method further comprises:
receiving, by the F1-terminating node, second indication information and the failure recovery information transmitted by a third network device, the second indication information being used to indicate that the F1-terminating node transfers the received failure recovery information to the first node via the second F1AP signaling.

15. The method according to supplement 12, wherein when the F1-terminating node is a secondary node, it transfers the failure information to a master node.

16. The method according to supplement 12, wherein the first F1AP signaling further comprises first indication information, the first indication information being used to indicate whether the F1-terminating node is a message destination node.

17. The method according to supplement 16, wherein according to the first indication information, the F1-terminating node determines to decode or transfer the failure information.

18. The method according to supplement 12, wherein first F1AP signaling to which different types of F1-terminating nodes correspond is different.

19. An method for processing information, characterized in that the method comprises:
receiving, by a first node, second-type backhaul radio link failure indication information transmitted by a parent node to which its first cell group corresponds; and
setting a primary path of a first signaling radio bearer by a first node to be referring to a second cell group different from the first cell group when the first signaling radio bearer of the first node is configured as a split signaling radio bearer and a primary path of a PDCP entity of the first signaling radio bearer refers to the first cell group.

20. The method according to supplement 19, wherein the first signaling radio bearer of the first node is not configured with PDCP-duplication transmission.

21. The method according to supplement 19, wherein the second-type backhaul radio link failure indication information is transmitted by the parent node when a failure of a backhaul radio link is detected by the parent node.

22. The method according to any one of supplements 19-21, wherein the method further comprises:
receiving, by the first node, third-type backhaul radio link failure indication information transmitted by the parent node; and
setting the primary path by the first node to be referring to the first cell group.

23. The method according to supplement 22, wherein the third-type backhaul radio link failure indication information is transmitted by the parent node when backhaul RLF recovery is successful.

24. An method for transmitting information, characterized in that the method comprises:
receiving, by a first node, second-type backhaul radio link failure indication information transmitted by a parent node to which a first cell group corresponds; and
transmitting a first RRC message to a network device connected to a second cell group via a signaling radio bearer corresponding to the second cell group or transmitting a first RRC message to an F1-terminating node via first F1AP signaling, by the first node.

25. The method according to supplement 24, wherein the first node is dual connected to the same donor node or different donor nodes

26. The method according to supplement 24, wherein the first node transmits the first RRC message by migrating the first RRC message via a signaling radio bearer corresponding to the first cell group to a signaling radio bearer corresponding to the second cell group.

27. The method according to supplement 26, wherein the signaling radio bearer corresponding to the first cell group is not configured as a split signaling radio bearer.

28. The method according to supplement 24, wherein the first RRC message comprises at least one of measurement information, failure information, assistance information and reconfiguration completion information; or, the RRC message comprises NAS information or non-3GPP dedicated information.

29. The method according to supplement 26, wherein the first RRC message is carried in a second RRC message.

30. The method according to supplement 24, wherein the first F1AP signaling is UE associated F1AP signaling.

31. The method according to supplement 24, wherein the first F1AP signaling is non-UE associated F1AP signaling.

32. The method according to supplement 24, wherein the first F1AP signaling is used for uplink RRC message transfer.

33. The method according to supplement 31, wherein the first F1AP signaling further comprises at least one of a signaling radio bearer identifier and a transaction identifier.

34. The method according to supplement 24, wherein the first F1AP signaling further comprises first indication information, the first indication information being used to indicate whether the F1-terminating node is a message destination node.

35. The method according to supplement 24, wherein first F1AP signaling to which different types of F1-terminating nodes correspond is different.

36. The method according to supplement 24, wherein the second-type backhaul radio link failure indication information is transmitted by the parent node when a failure of a backhaul radio link is detected by the parent node.

37. The method according to supplement 24, wherein the method further comprises:
receiving, by the first node, path reselection method configuration information transmitted by the network device, the path reselection method configuration information being used to indicate whether the first node transmits the first RRC message via the signaling radio bearer corresponding to the second cell group or transmits the first RRC message via the first F1AP signaling.

38. The method according to supplement 24, wherein the method further comprises:
receiving, by the first node, third-type backhaul radio link failure indication information transmitted by the parent node; and
transmitting the first RRC message by the first node via the signaling radio bearer of the first cell group.

39. The method according to supplement 24, wherein the third-type backhaul radio link failure indication information is transmitted by the parent node when backhaul RLF recovery is successful.

40. An method for transmitting information, characterized in that the method comprises:
receiving, by a second network device, an RRC message transmitted via a signaling radio bearer to which a second cell group corresponds or a first RRC message transmitted via the first F1AP signaling by a first node; and
transferring the first RRC message by the second network device to the first network device.

41. The method according to supplement 40, wherein when the second network device is a master network device of the first node and the first network device is a secondary network device of the first node, the method further includes:
initiating an RRC transfer procedure by the first network device, and receiving, by the second network device an RRC reply message transmitted by the first network device.

42. An method for transmitting information, characterized in that the method comprises:
receiving, by a first node, third-type backhaul radio link failure indication information transmitted by a parent node to which a first cell group corresponds; and
transmitting the first RRC message by the first node via a signaling radio bearer of the first cell group.

43. An method for processing information, characterized in that the method comprises:
receiving, by a first node, third-type backhaul radio link failure indication information transmitted by a parent node to which its first cell group corresponds; and
setting a primary path of a PDCP entity of the first signaling radio bearer to be referring to the first cell group by the first node when the first signaling radio bearer of the first node is configured as a split signaling radio bearer and the primary path refers to the second cell group.

44. The method according to supplement 43, wherein the third-type backhaul radio link failure indication information is transmitted by the parent node when backhaul RLF recovery is successful.

45. An method for processing information, characterized in that the method comprises:
receiving, by a first node, second-type backhaul radio link failure indication information transmitted by a parent node to which its first cell group corresponds; and
suspending an SRB passing a first cell group link by the first node.

46. The method according to supplement 45, wherein the method includes:
suspending the SRB by the first node when the SRB passing the first cell link (a parent node link) is not configured as a split SRB.

47. The method according to supplement 45, wherein the method includes:
receiving, by the first node, third-type backhaul radio link failure indication information transmitted by the parent node; and
resuming the suspended SRB passing the first cell group link by the first node.

48. A first node, comprising a memory and a processor, the memory storing a computer program, wherein the processor is configured to execute the computer program to carry out the method described in any one of supplements 1-11, 19-39 and 42-47.

49. A network node, comprising a memory and a processor, the memory storing a computer program, wherein the processor is configured to execute the computer program to carry out the method described in any one of supplements 12-18 and 40-41.

50. A communication system, comprising a first node, the first node executing the method described in any one of supplements 1-11, 19-39 and 42-47.

51. A communication system, comprising a network node, the network node executing the method described in any one of supplements 12-18 and 40-41.

1. An apparatus for transmitting information, applicable to a first node, the apparatus comprising:
processor circuitry configured to connect to a plurality of parent nodes, wherein a radio link failure (RLF) occurs in a master cell group (MCG); and
a transmitter configured to transmit failure information to an F1-terminating node of the first node via first F1 application protocol (F1AP) signaling.

2. The apparatus according to claim 1, wherein the first F1AP signaling is non-UE associated F1AP signaling.

3. The apparatus according to claim 1, wherein the first F1AP signaling is used for uplink RRC message transfer.

4. The apparatus according to claim 1, wherein the first node is not configured with a split signaling radio bearer 1 (SRB1) and a split signaling radio bearer 3 (SRB3).

5. The apparatus according to claim 1, wherein the first node is dual-connected to the same donor node or different donor nodes, an F1-C connection to which the first F1AP signaling belongs passes a secondary cell group (SCG) link, and the failure information is MCG failure information.

6. An apparatus for processing information, applicable to a first node, the apparatus comprising:
a first receiver configured to receive second-type backhaul radio link failure indication information transmitted by a parent node to which a first cell group corresponds; and
second processor circuitry configured to set a primary path of a first signaling radio bearer to be referring to a second cell group different from the first cell group when the first signaling radio bearer of the first node is configured as a split signaling radio bearer and a primary path of a packet data convergence protocol (PDCP) entity of the first signaling radio bearer refers to the first cell group.

7. The apparatus according to claim 6, wherein the first signaling radio bearer of the first node is not configured with PDCP-duplication.

8. The apparatus according to claim 6, wherein the second-type backhaul radio link failure indication information is transmitted by the parent node when a failure of a backhaul radio link is detected by the parent node.

9. The apparatus according to claim 6, the apparatus further comprising:
a second receiver configured to receive third-type backhaul radio link failure indication information transmitted by the parent node; and
third processor circuitry configured to set the primary path to be referring to the first cell group.

10. The apparatus according to claim 9, wherein the third-type backhaul radio link failure indication information is transmitted by the parent node when backhaul RLF recovery is successful.

11. An apparatus for transmitting information, applicable to a first node, the apparatus comprising:
a receiver configured to receive second-type backhaul radio link failure indication information transmitted by a parent node to which a first cell group corresponds; and
a transmitter configured to transmit a first RRC message to a network device connected to a second cell group via a signaling radio bearer corresponding to the second cell group or transmit a first RRC message to an F1-terminating node via first F1AP signaling.

12. The apparatus according to claim 11, wherein the transmitter transmits the first RRC message by migrating the first RRC message via a signaling radio bearer corresponding to the first cell group to a signaling radio bearer corresponding to the second cell group.

13. The apparatus according to claim 11, wherein the signaling radio bearer corresponding to the first cell group is not configured as a split signaling radio bearer.

14. The apparatus according to claim 11, wherein the first RRC message comprises at least one of measurement information, failure information, assistance information and reconfiguration completion information; or, the RRC message comprises NAS information or non-3GPP dedicated information.

15. The apparatus according to claim 12, wherein the first RRC message is carried in a second RRC message.

16. The apparatus according to claim 11, wherein the first F1AP signaling is non-UE associated F1AP signaling.

17. The apparatus according to claim 11, wherein the first F1AP signaling is used for uplink RRC message transfer.

18. The apparatus according to claim 11, wherein the first F1AP signaling further comprises first indication information, the first indication information being used to indicate whether the F1-terminating node is a message destination node.

19. The apparatus according to claim 11, wherein first F1AP signaling to which different types of F1-terminating nodes correspond is different.

20. The apparatus according to claim 11, wherein the second-type backhaul radio link failure indication information is transmitted by the parent node when a failure of a backhaul radio link is detected by the parent node.
